(19) United States
(12) Patent Application Publication
(10) Pub. No.: US 2023/0247581 A1
(43) Pub. Date: Aug. 3, 2023

(54) RADIO BASE STATION

(71) Applicant: NTT DOCOMO, INC., Tokyo (JP)

(72) Inventors: Masato Taniguchi, Tokyo (JP); Tianyang Min, Tokyo (JP); Rina Suzuki, Tokyo (JP); Kazuaki Takeda, Tokyo (JP)

(73) Assignee: NTT DOCOMO, INC., Tokyo (JP)

(21) Appl. No.: 18/011,970

(22) PCT Filed: Jul. 10, 2020
(86) PCT No.: PCT/JP2020/027147

§ 371 Date: Dec. 21, 2022

(51) Int. Cl. H04W 64/00; H04W 24/10

(52) U.S. Cl. CPC H04W 64/00; H04W 24/10

(57) ABSTRACT

A radio base station includes: a transmission unit that transmits a measurement report according to a protocol based on a location service to a positioning server; and a control unit that includes, in the measurement report, a measurement result of a cell belonging to a different radio access technology, together with identification information uniquely specifying the cell belonging to the different radio access technology.

### TECHNICAL FIELD

The present disclosure relates to a radio base station supporting a location service (LCS).

### BACKGROUND ART

The 3rd Generation Partnership Project (3GPP) has specified Long Term Evolution (LTE), and has also advanced specification for LTE-Advanced (hereinafter referred to as LTE including LTE-Advanced) for the purpose of further speeding up LTE, and 5th generation mobile communication system (also called 5G, New Radio (NR), or next generation (NG)).

In the LTE, a location service (LCS) function of a terminal (User Equipment (UE)) has been realized as a control plane protocol. Specifically, an LTE Positioning Protocol (LPP) and an LPP annex (LPPa), which are LCS dedicated protocols, have been defined (Non Patent Literature 1).

The LPP is a protocol terminated between the UE and a positioning server (Enhanced Serving Mobile Location Center (E-SMLC)). In addition, the LPPa is a protocol terminated between a radio base station (eNB) and the E-SMLC.

### CITATION LIST

### Non Patent Literature

Non Patent Literature 1; 3GPP TS 36.455 V16.0.0, 3rd Generation Partnership Project; Technical Specification Group Radio Access Network; Evolved Universal Terrestrial Radio Access (E-UTRA); LTE Positioning Protocol A (LPPa) (Release 16), 3GPP, March 2020

### SUMMARY OF INVENTION

The LPPa described above has the following problem. For example, the eNB receives a measurement result regarding a different Radio Access Technologies (RATs) from the UE, and transmits a measurement report including the measurement result to the E-SMLC. For example, the measurement result includes a measurement result regarding the NR, and the measurement result regarding the NR includes NR Absolute Radio-Frequency Channel Number (ARFCN), NR Physical Cell Identifier (PCI), NR Synchronization Signal Reference Signal Received Power (SS-RSRP), NR Synchronization Signal Reference Signal Received Quality (SS-RSRQ), and the like.

However, since information uniquely specifying a cell of the NR is not included in the measurement result, the E-SMLC cannot calculate and grasp location information of the UE with high accuracy.

Therefore, the following disclosure has been made in view of such a situation, and an object of the following disclosure is to provide a radio base station capable of calculating and grasping location information of a UE with high accuracy.

An aspect of the present disclosure is a radio base station including: a transmission unit that transmits a measurement report according to a protocol based on a location service to a positioning server; and a control unit that includes, in the measurement report, a measurement result of a cell belonging to a different radio access technology, together with identification information uniquely specifying the cell belonging to the different radio access technology.

### BRIEF DESCRIPTION OF DRAWINGS

FIG. 1 is an overall schematic configuration diagram of a radio communication system 10.

FIG. 2 is a functional block diagram of an eNB 100A.

FIG. 3 is a diagram illustrating an example of a correspondence relationship.

FIG. 4 is a diagram illustrating a sequence of Enhanced-cell ID (E-CID) Measurement Initiation.

FIG. 5 is a diagram illustrating an example of an information element.

FIG. 6 is a diagram illustrating an example of Result NR (ASN.1 format).

FIG. 7 is a diagram illustrating an example of a hardware configuration of the eNB 100A.

### DESCRIPTION OF EMBODIMENTS

Hereinafter, embodiments will be described with reference to the drawings. Note that the same functions or configurations will be denoted by the same or similar reference numerals, and a description thereof will be appropriately omitted.

### (1) OVERALL SCHEMATIC CONFIGURATION OF RADIO COMMUNICATION SYSTEM

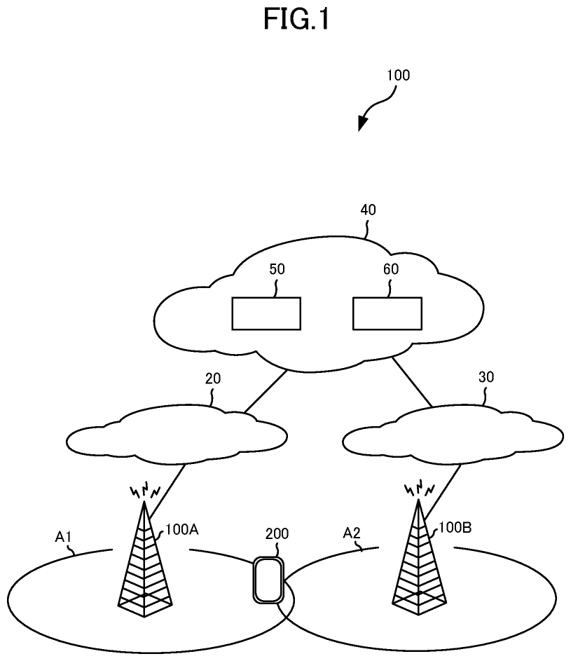

FIG. 1 is an overall schematic configuration diagram of a radio communication system 10 according to the present embodiment. The radio communication system 10 is a radio communication system according to Long Term Evolution (LTE) and 5th generation (5G) New Radio (NR). Note that the LTE may be referred to as 4th generation (4G) and the NR may be referred to as 5G.

In addition, the LTE and the NR may be interpreted as a radio access technology (RAT), and in the present embodiment, the LTE may be referred to as a first radio access technology and the NR may be referred to as a second radio access technology.

The radio communication system 10 includes an Evolved Universal Terrestrial Radio Access Network 20 (hereinafter, referred to as an E-UTRAN 20) and a Next Generation-Radio Access Network 30 (hereinafter, referred to as an NG RAN 30). In addition, the radio communication system 10 includes a terminal 200 (hereinafter, referred to as a User Equipment (UE) 200).

The E-UTRAN 20 includes an eNB 100A, which is a radio base station according to the LTE. The NG RAN 30 includes a gNB 100B, which is a radio base station according to the 5G (NR).

The eNB 100A, the gNB 100B, and the UE 200 can support carrier aggregation (CA) using a plurality of component carriers (CCs), dual connectivity (DC) that simultaneously performs communication between the UE and each of a plurality of NG-RAN nodes, and the like.

The E-UTRAN 20 is connected to a core network 40 for LTE. Note that the E-UTRAN 20, the NG RAN 30, and the core network 40 may be simply called networks.

A positioning server 50 (hereinafter, referred to as an Enhanced Serving Mobile Location Center (E-SMLC) 50) is provided in the core network 40. A management server 60 (hereinafter, referred to as an Operation Administration and Management server (OAM server) 60) may be provided in the core network 40.

The E-SMLC 50 supports a Location Service (LCS) function of the UE 200. The LCS is, for example, a service that provides location information or the like positioned by the UE 200 using a Global Positioning System (GPS) mounted in the UE 200 or a pilot signal from the eNB 100A.

In addition, the eNB 100A can provide the location information of the UE 200 using an Enhanced-Cell ID (E-CID) to the E-SMLC 50 in response to a request from the E-SMLC 50.

An LTE Positioning Protocol (LPP) annex (LPPa), which is a control plane protocol and an LCS dedicated protocol, is used between the eNB 100A and the E-SMLC 50. The LPPa is defined in 3GPP TS 36.455 V16.0.0. The LPPa is terminated in the eNB 100A and the E-SMLC 50, and is transparent to a Mobility Management Entity (MME) (not illustrated).

In addition, an LPP is used between the UE 200 and the E-SMLC 50. The LPP is defined in 3GPP TS 36.355 V15.6.0. The LPP is terminated in the UE 200 and the E-SMLC 50, and is transparent to the eNB 100A and the MME.

The eNB 100A and the gNB 100B can form an area (that may be expressed as a cell) in which radio communication with the UE 200 can be executed, specifically, an area A1 or an area A2.

Here, the area A1 may be interpreted as an area in which the UE 200 can communicate with the eNB 100A. The area A2 may be interpreted as an area in which the UE 200 can communicate with the gNB 100B. The area A1 and the area A2 may overlap each other, and in an area where the area A1 and the area A2 overlap each other, E-UTRA-NR Dual Connectivity (EN-DC) or NR-EUTRA Dual Connectivity (NE-DC) in which the UE 200 simultaneously performs communication with the eNB 100A and the gNB 100B may be executed.

In such a background, the UE 200 transmits a measurement report including Measurement Results of a serving cell and a peripheral cell to the eNB 100A in a case of performing communication using a cell belonging to the eNB 100A as a Primary Cell (PCell). The measurement report includes information (measID) associated with a frequency of a target cell, physical cell identification information (PCI) of the target cell, received power (Reference Signal Received Power (RSRP)) of the target cell, and received quality (Reference Signal Received Quality (RSRQ)) of the target cell, and the like. For example, in a case where a signal of a cell (hereinafter, referred to as an NR cell) belonging to the gNB 100B can be observed by the UE 200, the measurement report may include a measurement result (Result NR) of the cell belonging to the gNB 100B. For example, the measurement report may include measID associated with a frequency of the NR cell, PCI of the NR cell, RSRP of the NR cell, RSRQ of the NR cell, and the like.

Further, the eNB 100A transmits a positioning result of the UE 200 based on the LPPa described above to the E-SMLC 50. The positioning result of the UE 200 transmitted to the E-SMLC 50 may be referred to as a measurement report (MR). The measurement report (MR) may include a measurement result of a RAT different from a RAT to which the eNB 100A belongs. Such a measurement result may be referred to as an Inter-RAT Measurement Result. For example, in a case where the measurement report received from the UE 200 includes a measurement result of the NR cell, the measurement report (MR) transmitted from the eNB 100A to the E-SMLC 50 may include the PCI of the NR cell, the RSRP of the NR cell, and the RSRQ of the NR cell. Further, in the present embodiment, the measurement report (MR) includes identification information uniquely specifying the NR cell. A Cell Global Identity (CGI) of the NR cell may be used as such identification information.

Note that the PCI is an information element assigned by a radio base station, and the same PCI can be used between different radio base stations. Therefore, the PCI is not interpreted as identification information uniquely specifying a cell, and the CGI is used as the identification information uniquely specifying a cell.

The OAM server 60 is an example of a management server in charge of maintenance and management of the radio communication system 10. For example, the OAM server 60 manages a cell belonging to the E-UTRAN 20 (hereinafter, referred to as an LTE cell) and a cell belonging to the NG RAN 30 (NR cell). The OAM server 60 manages a frequency of each cell, PCI of each cell, and a CGI of each cell. The OAM server 60 transmits correspondence information associating CGIs of the LTE cell belonging to the eNB 100A and the NR cell belonging to the gNB 100B with each other to the eNB 100A. The correspondence information may associate at least any one of a frequency and PCI of the NR cell with the LTE cell belonging to the eNB 100A.

### (2) FUNCTIONAL BLOCK CONFIGURATION OF RADIO COMMUNICATION SYSTEM

Next, a functional block configuration of the radio communication system 10 will be described. Specifically, a functional block configuration of the eNB 100A will be described.

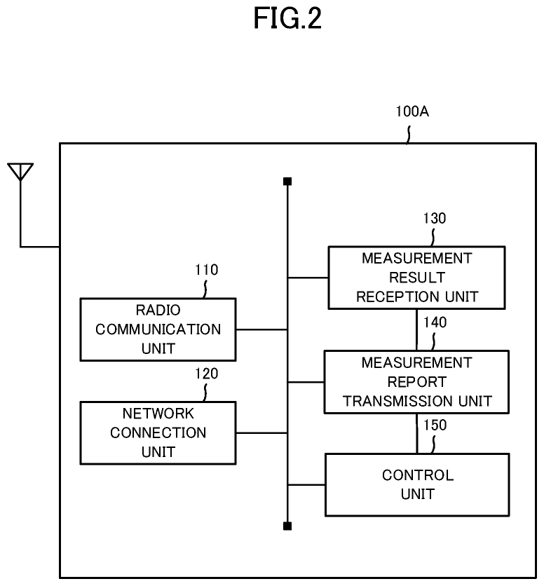

FIG. 2 is a functional block diagram of the eNB 100A. As illustrated in FIG. 2, the eNB 100A includes a radio communication unit 110, a network connection unit 120, a measurement result reception unit 130, a measurement report transmission unit 140, and a control unit 150.

The radio communication unit 110 transmits a downlink signal (DL signal) according to the LTE. The radio communication unit 110 receives an uplink signal (UL signal) according to the LTE.

The network connection unit 120 performs communication with the E-SMLC 50 and the OAM server 60. In the present embodiment, the network connection unit 120 constitutes a reception unit that receives the correspondence information described above.

The measurement result reception unit 130 receives various measurement results by the UE 200. In particular, in the present embodiment, the measurement result reception unit 130 can receive a measurement result regarding the E-UTRAN 20 and the NG RAN 30 from the UE 200. Note that such a measurement result may be referred to as an Inter-RAT Measurement Result.

The measurement report transmission unit 140 transmits a measurement report (MR) including the measurement result in the UE 200 to the E-SMLC 50. Specifically, the measurement report transmission unit 140 transmits a measurement report according to a protocol based on the location service (LCS) to the E-SMLC 50. In the present embodiment, the measurement report transmission unit 140 constitutes a transmission unit.

More specifically, the measurement report transmission unit 140 can return an E-CID MEASUREMENT INITIATION RESPONSE according to the LPPa to the E-SMLC 50 in response to an E-CID MEASUREMENT INITIATION REQUEST, which is a request from the E-SMLC 50. As such, the measurement report transmission unit 140 can transmit the measurement report according to a location information related protocol (LPPa) applied between the eNB 100A and the E-SMLC 50.

The E-CID MEASUREMENT INITIATION RESPONSE is defined in 3GPP TS 36.455 V16.0.0 Section 8.2.1. Note that details of the E-CID MEASUREMENT INITIATION RESPONSE will be described later.

The E-CID MEASUREMENT INITIATION RESPONSE may include location information (E-CID Measurement Result) of the UE 200 using an Enhanced-Cell ID (E-CID).

Note that the radio communication system 10 may support the following positioning methods including a positioning method of the UE 200 using the Enhanced-Cell ID (E-CID).

(i) A-GNSS (Assisted-Global Navigation Satellite System):

This is a positioning method of correcting a GPS positioning information positioned by the UE 200 using satellite information of a GPS acquired by a network. There are two types of final positioning results, a value calculated by the E-SMLC 50 on the network side and a value calculated by the UE 200 side.

(ii) OTDOA (Observed Time Difference of Arrival):

This is a method of calculating a distance from a time difference between pilot signals received from a plurality of eNBs and performing positioning from an intersection point of a hyperbola.

(iii) E-CID (Enhanced-Cell ID):

This is a method of performing positioning from a one-way propagation delay calculated from a transmission/reception timing difference and an angle of arrival (AoA) of a signal, in addition to a notified cell ID.

The control unit 150 controls each functional block constituting the eNB 100A. In particular, in the present embodiment, the control unit 150 executes control regarding an NR cell belonging to a different RAT (here, NG RAN 30) and control regarding positioning (location service) of the UE 200.

Specifically, in a case of transmitting a measurement report (for example, E-CID MEASUREMENT INITIATION RESPONSE) regarding the NR cell belonging to the different RAT (here, NG RAN 30), the control unit 150 includes, in the measurement report, a measurement result of the NR cell together with the CGI uniquely specifying the NR cell.

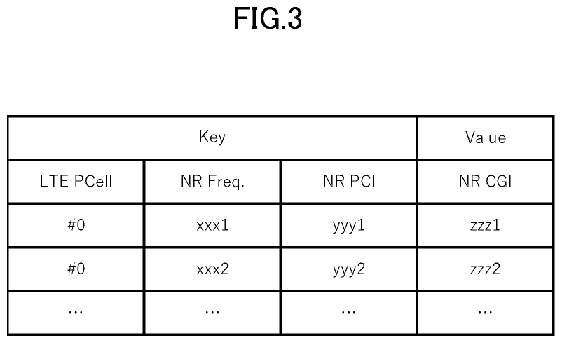

The control unit 150 specifies the CGI of the NR cell by referring to the correspondence information received from the OAM server 60. For example, the correspondence information may be a Table illustrated in FIG. 3. For example, Table includes LTE PCell, NR Freq., and NR PCI as Keys and includes NR CGI as Value. The LTE PCell is an LTE cell belonging to the eNB 100A and is an LTE cell receiving a Measurement Result from the UE 200. Information for specifying the LTE PCell may be the PCI of the LTE cell or may be a combination of identification information of the eNB 100A and the PCI of the LTE cell. The NR Freq. is a frequency used in an NR cell provided as a peripheral cell of the LTE PCell. The NR PCI is PCI of the NR cell provided as the peripheral cell of the LTE PCell. The NR CGI is CGI (identification information) uniquely specifying the NR cell provided as the peripheral cell of the LTE PCell.

Specifically, the control unit 150 specifies the NG CGI by referring to at least a correspondence relationship between the LTE PCell and the NR CGI in a case where the measurement result has been received from the UE 200 existing in the LTE cell (LTE PCell) belonging to the eNB 100A. Note that the measurement result received from UE 200 includes the measurement result of the NR cell.

Further, in a case where two or more NR cells are provided as peripheral cells of the LTE PCell, the control unit 150 specifies the NG CGI by referring to a correspondence relationship between at least any one of the NR Freq. and the NR PCI and the NR CGI. Note that the measurement result received from the UE 200 includes the measurement result of the NR cell, and includes at least one of information (meas ID) associated with the NR Freq. and the NR PCI.

### (3) OPERATION OF RADIO COMMUNICATION SYSTEM

Next, an operation of the radio communication system 10 will be described. Specifically, an operation of transmitting the measurement report (MR) including the measurement result (Inter-RAT Measurement Result) of the NR cell belonging to the RAT (NG RAN 30) different from the RAT (E-UTRAN 20) to which the eNB 100A belongs from the eNB 100A to the E-SMLC 50 will be described.

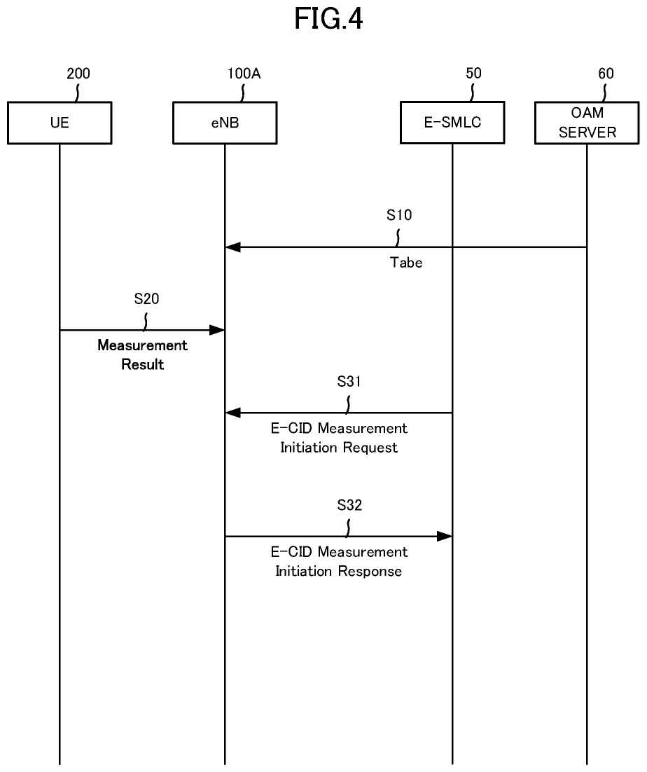

FIG. 4 illustrates an example of a communication sequence regarding positioning of the UE 200 using the Enhanced-cell ID (E-CID) according to the present embodiment.

Specifically, FIG. 4 illustrates a sequence of E-CID Measurement Initiation. The E-CID Measurement Initiation is defined in 3GPP TS 36.455 V16.0.0 Section 8.2.1.

An E-CID Measurement Initiation procedure is executed for the E-SMLC 50 to request the eNB 100A to report E-CID Measurement used by the E-SMLC 50 in order to calculate a location of the UE 200.

As illustrated in FIG. 4, in step S10, the OAM server 60 transmits a correspondence relationship (for example, Table) associating at least the LTE PCell and the NR CGI with each other to the eNB 100A. As described above, Table may show the correspondence relationship illustrated in FIG. 3.

In step S20, the eNB 100A receives a Measurement Result from the UE 200 existing in the LTE cell (LTE PCell) belonging to the eNB 100A. Here, the measurement result includes a measurement result of an NR cell provided as a peripheral cell of the LTE PCell.

In step S31, the E-SMLC 50 transmits an E-CID MEASUREMENT INITIATION REQUEST for requesting the eNB 100A to report the E-CID Measurement to the eNB 100A. The E-CID MEASUREMENT INITIATION REQUEST may include an LPPa Transaction ID, an E-SMLC Measurement ID, a Measurement Periodicity, Measurement Quantities, and the like. The Measurement Quantities may include a Cell-ID and an Angle of Arrival (AoA).

In step S32, in a case where the eNB 100A can start the requested E-CID measurement, the eNB 100A responds to the E-CID MEASUREMENT INITIATION REQUEST with an E-CID MEASUREMENT INITIATION RESPONSE.

The E-CID MEASUREMENT INITIATION RESPONSE may be transmitted by the eNB 100A, and may indicate that the requested E-CID Measurement has normally started.

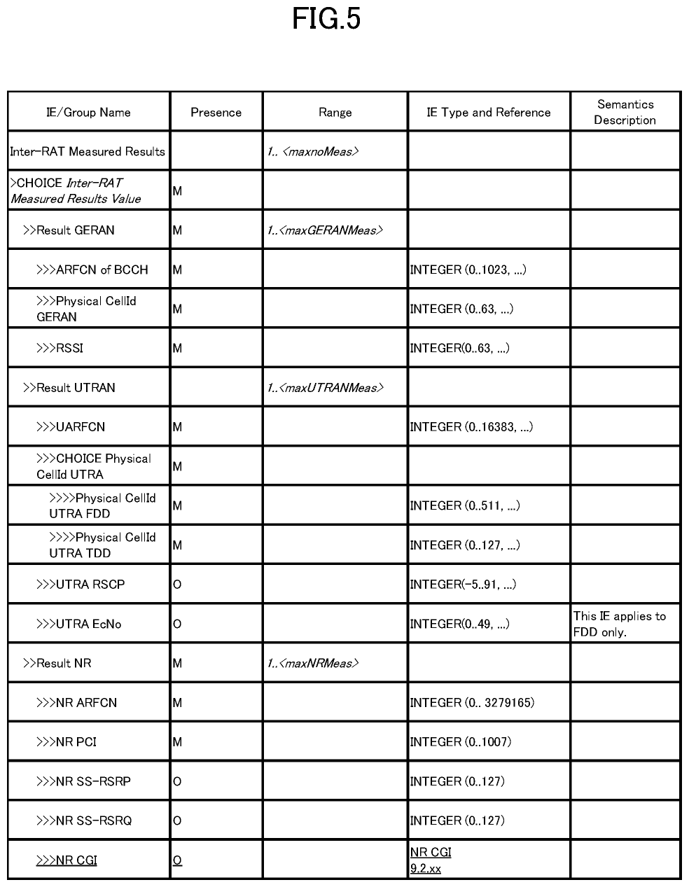

FIG. 5 illustrates a configuration example of an information element (IE) included in the E-CID MEASUREMENT INITIATION RESPONSE according to the present embodiment. In FIG. 5, an Inter-RAT Measurement Result included in the E-CID MEASUREMENT INITIATION RESPONSE is illustrated.

As illustrated in FIG. 5, in the Inter-RAT Measurement Result, Result GERAN, Result UTRAN, Result NR, and the like, are defined as values that can be taken by Inter-RAT Measured Results. The Result NR will be mainly described in the present embodiment, but the Result NR includes NR CGI in addition to NR ARFCN, NR PCI, NR SS-RSRP, and NR SS-RSRQ.

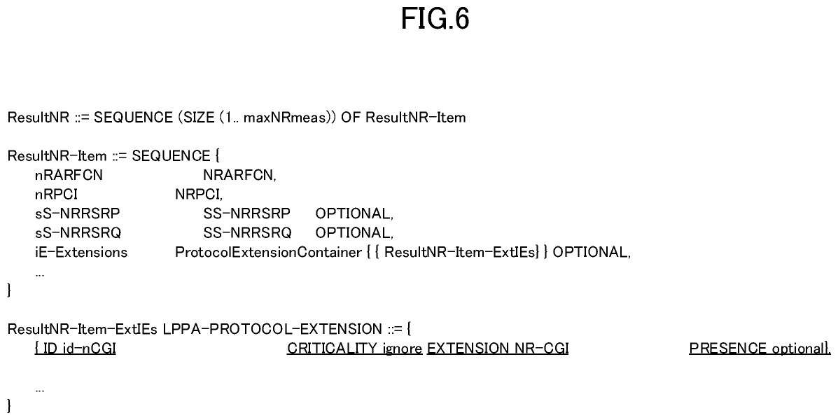

FIG. 6 illustrates an example of Protocol Data Unit (PDU) Definition (ASN.1 format) of the E-CID MEASUREMENT INITIATION RESPONSE. In FIG. 6, the Result NR described above is illustrated.

As illustrated in FIG. 6, ResultNR-Item-ExIEs is defined as an extended IE included in the Result NR, and nCGI (NR CGI) may be defined as an IE that can be taken by ResultNR-Item-ExIEs.

### (4) ACTION AND EFFECT

According to the embodiment described above, the following effects can be obtained. Specifically, the eNB 100A includes, in the measurement report (for example, E-CID MEASUREMENT INITIATION RESPONSE), a measurement result (NR SS-RSRP, NR SS-RSRQ) of the NR cell belonging to the different RAT, together with the identification information (NR CGI) uniquely specifying the NR cell belonging to the different RAT. According to such a configuration, the E-SMLC 50 can calculate and grasp highly accurate location information of the UE by the NR CGI.

In the embodiment described above, the E-SMLC 50 does not specify the NR CGI, but the eNB 100A specifies the NR CGI. In other words, the E-SMLC 50 does not grasp correspondence relationships for all the eNBs 100A, but each eNB 100A grasps a correspondence relationship in a distributed manner. With such a configuration, it is possible to prevent a situation in which an amount of correspondence relationships that should be grasped by the E-SMLC 50 becomes huge, such that a processing load of the E-SMLC 50 increases, and the entire efficiency of the radio communication system 10 resultantly decreases.

### (5) OTHER EMBODIMENTS

Although the embodiment has been described hereinabove, it is obvious to those skilled in the art that the present disclosure is not limited to the description of the embodiment, and can be variously modified and improved.

For example, in the embodiment described above, the correspondence information is transmitted from the OAM server 60 to the eNB 100A. However, the embodiment is not limited thereto. The correspondence information may be configured in the eNB 100A by an operator or the like.

In the embodiment described above, the eNB 100A includes, in the measurement report (MR) for the E-SMLC 50, the measurement result of the NR cell belonging to the NG RAN 30, together with the CGI of the NR cell belonging to the different RAT (NG RAN 30). However, the embodiment is not limited thereto. The gNB 100B may include, in a measurement report (MR) for the E-SMLC 50, a measurement result of the LTE cell belonging to the E-UTRAN 20, together with CGI of the LTE cell belonging to a different RAT (E-UTRAN 20).

The CGI (identification information) of the NR cell has been included in the E-CID MEASUREMENT INITIATION RESPONSE in the embodiment described above, but the identification information may be included in a message other than the E-CID MEASUREMENT INITIATION RESPONSE. For example, the identification information may be included in an E-CID MEASUREMENT REPORT.

Moreover, the block diagram used for explaining the embodiments (FIG. 2) illustrates blocks of functional unit. Those functional blocks (structural components) can be realized by a desired combination of at least one of hardware and software. Means for realizing each functional block is not particularly limited. That is, each functional block may be realized by one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, a functional block (component) that causes transmitting may be called a transmitting unit or a transmitter. For any of the above, as explained above, the realization method is not particularly limited to any one method.

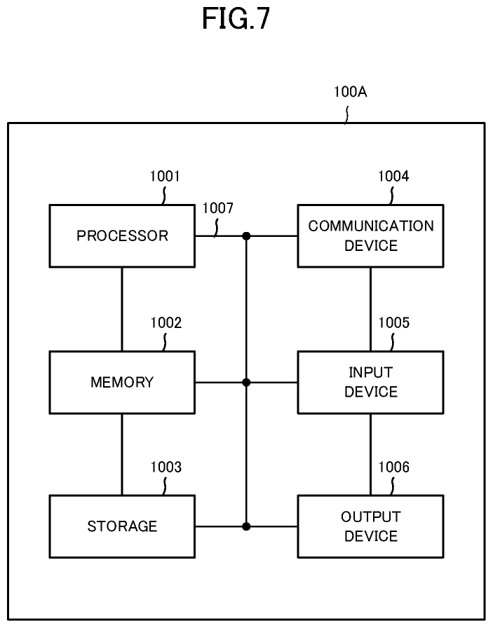

Furthermore, the eNB 100A explained above can function as a computer that performs the processing of the radio communication method of the present disclosure. FIG. 7 is a diagram illustrating an example of a hardware configuration of the eNB 100A. As illustrated in FIG. 7, the eNB 100A can be configured as a computer device including a processor 1001, a memory 1002, a storage 1003, a communication device 1004, an input device 1005, an output device 1006, a bus 1007, and the like.

Furthermore, in the following explanation, the term “device” can be replaced with a circuit, device, unit, and the like. Hardware configuration of the device can be constituted by including one or plurality of the devices illustrated in the figure, or can be constituted by without including a part of the devices.

The functional blocks (see FIG. 2) of the eNB 100A can be realized by any of hardware elements of the computer device or a desired combination of the hardware elements.

Moreover, the processor 1001 performs computing by loading a predetermined software (computer program) on hardware such as the processor 1001 and the memory 1002, and realizes various functions of the eNB 100A by controlling communication via the communication device 1004, and controlling reading and/or writing of data on the memory 1002 and the storage 1003.

The processor 1001, for example, operates an operating system to control the entire computer. The processor 1001 can be configured with a central processing unit (CPU) including an interface with a peripheral device, a control device, a computing device, a register, and the like.

Moreover, the processor 1001 reads a computer program (program code), a software module, data, and the like from the storage 1003 and/or the communication device 1004 into the memory 1002, and executes various processes according to the data. As the computer program, a computer program that is capable of executing on the computer at least a part of the operation explained in the above embodiments is used. Alternatively, various processes explained above can be executed by one processor 1001 or can be executed simultaneously or sequentially by two or more processors 1001. The processor 1001 can be implemented by using one or more chips. Alternatively, the computer program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM), and the like. The memory 1002 can be called register, cache, main memory (main memory), and the like. The memory 1002 can store therein a computer program (computer program codes), software modules, and the like that can execute the method according to the embodiment of the present disclosure.

The storage 1003 is a computer readable recording medium. Examples of the storage 1003 include at least one of an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

In addition, the respective devices, such as the processor 1001 and the memory 1002, are connected to each other with the bus 1007 for communicating information thereamong. The bus 1007 can be constituted by a single bus or can be constituted by separate buses between the devices.

Further, the device is configured to include hardware such as a microprocessor, a digital signal processor (Digital Signal Processor: DSP), Application Specific Integrated Circuit (ASIC), Programmable Logic Device (PLD), and Field Programmable Gate Array (FPGA). Some or all of these functional blocks may be realized by the hardware. For example, the processor 1001 may be implemented by using at least one of these hardware.

Notification of information is not limited to that explained in the above aspect/embodiment, and may be performed by using a different method. For example, the notification of information may be performed by physical layer signaling (for example, Downlink Control Information (DCI), Uplink Control Information (UCI), upper layer signaling (for example, RRC signaling, Medium Access Control (MAC) signaling, notification information (Master Information Block (MIB), System Information Block (SIB)), other signals, or a combination of these. The RRC signaling may be called RRC message, for example, or can be RRC Connection Setup message, RRC Connection Reconfiguration message, or the like.

Each of the above aspects/embodiments can be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (Registered Trademark), GSM (Registered Trademark), CDMA2000, Ultra Mobile Broadband (UMB), IEEE 802.11 (Wi-Fi (Registered Trademark)), IEEE 802.16 (WiMAX (Registered Trademark)), IEEE 802.20, Ultra-WideBand (UWB), Bluetooth (Registered Trademark), a system using any other appropriate system, and a next-generation system that is expanded based on these. Further, a plurality of systems may be combined (for example, a combination of at least one of the LTE and the LTE-A with the 5G).

As long as there is no inconsistency, the order of processing procedures, sequences, flowcharts, and the like of each of the above aspects/embodiments in the present disclosure may be exchanged. For example, the various steps and the sequence of the steps of the methods explained above are exemplary and are not limited to the specific order mentioned above.

The specific operation that is performed by the base station in the present disclosure may be performed by its upper node in some cases. In a network constituted by one or more network nodes having a base station, the various operations performed for communication with the terminal may be performed by at least one of the base station and other network nodes other than the base station (for example, MME, S-GW, and the like may be considered, but not limited thereto). In the above, an example in which there is one network node other than the base station is explained; however, a combination of a plurality of other network nodes (for example, MME and S-GW) may be used.

Information and signals (information and the like) can be output from an upper layer (or lower layer) to a lower layer (or upper layer). It may be input and output via a plurality of network nodes.

The input/output information can be stored in a specific location (for example, a memory) or can be managed in a management table. The information to be input/output can be overwritten, updated, or added. The information can be deleted after outputting. The inputted information can be transmitted to another device.

The determination may be made by a value (0 or 1) represented by one bit or by Boolean value (Boolean; true or false), or by comparison of numerical values (for example, comparison with a predetermined value).

Each aspect/embodiment described in the present disclosure may be used separately or in combination, or may be switched in accordance with the execution. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, when a software is transmitted from a website, a server, or some other remote source by using at least one of a wired technology (coaxial cable, fiber optic cable, twisted pair, Digital Subscriber Line (DSL), or the like) and a wireless technology (infrared light, microwave, or the like), then at least one of these wired and wireless technologies is included within the definition of the transmission medium.

Information, signals, or the like mentioned above may be represented by using any of a variety of different technologies. For example, data, instruction, command, information, signal, bit, symbol, chip, or the like that may be mentioned throughout the above description may be represented by voltage, current, electromagnetic wave, magnetic field or magnetic particle, optical field or photons, or a desired combination thereof.

It should be noted that the terms described in this disclosure and terms necessary for understanding the present disclosure may be replaced by terms having the same or similar meanings. For example, at least one of a channel and a symbol may be a signal (signaling). Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like can be used interchangeably. The base station may also be referred to with the terms such as a macro cell, a small cell, a femtocell, or a pico cell.

The base station can accommodate one or more (for example, three) cells (also called sectors). In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a part or all of the coverage area of a base station and/or a base station subsystem that performs communication service in this coverage.

In the present disclosure, the terms “mobile station (Mobile Station: MS)”, “user terminal”, “user equipment (User Equipment: UE)”, “terminal” and the like can be used interchangeably.

The mobile station is called by the persons skilled in the art as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or with some other suitable term.

At least one of a base station and a mobile station may be called a transmitting device, a receiving device, a communication device, or the like. Note that, at least one of a base station and a mobile station may be a device mounted on a moving body, a moving body itself, or the like. The moving body may be a vehicle (for example, a car, an airplane, or the like), a moving body that moves unmanned (for example, a drone, an automatically driven vehicle, or the like), a robot (manned type or unmanned type). At least one of a base station and a mobile station can be a device that does not necessarily move during the communication operation. For example, at least one of a base station and a mobile station may be an Internet of Things (IoT) device such as a sensor.

Also, a base station in the present disclosure may be read as a mobile station (user terminal, hereinafter the same). For example, each of the aspects/embodiments of the present disclosure may be applied to a configuration that allows a communication between a base station and a mobile station to be replaced with a communication between a plurality of mobile stations (for example, may be referred to as Device-to-Device (D2D), Vehicle-to-Everything (V2X), or the like). In this case, the mobile station may have the function of the base station. Words such as “uplink” and “downlink” may also be replaced with wording corresponding to inter-terminal communication (for example, “side”). For example, terms such as an uplink channel, a downlink channel, or the like may be read as a side channel.

Likewise, a mobile station in the present disclosure may be read as a base station. In this case, the base station may have the function of the mobile station.

A radio frame may be configured with one or a plurality of frames in a time domain. One frame or each of the plurality of frames in the time domain may be referred to as a subframe. The subframe may also be configured with one or a plurality of slots in the time domain. The subframe may have a fixed time length (for example, 1 ms) that does not depend on a numerology.

The numerology may be a communication parameter applied to at least one of transmission and reception of a certain signal or channel. The numerology may indicate at least one of, for example, a subcarrier spacing (SCS), a bandwidth, a symbol length, a cyclic prefix length, a transmission time interval (TTI), the number of symbols per TTI, a radio frame configuration, specific filtering processing performed by a transceiver in a frequency domain, a specific windowing processing performed by the transceiver in the time domain, and the like.

The slot may be configured with one or a plurality of symbols (Orthogonal Frequency Division Multiplexing (OFDM) symbols, Single Carrier Frequency Division Multiple Access (SC-FDMA) symbols, or the like) in the time domain. The slot may be a time unit based on a numerology.

The slot may include a plurality of mini-slots. Each mini-slot may be configured with one or a plurality of symbols in the time domain. In addition, the mini-slot may be referred to as a sub-slot. The mini-slot may be configured with a smaller number of symbols than that of the slot. A PDSCH (or PUSCH) transmitted in a time unit larger than the mini-slot may be referred to as PDSCH (or PUSCH) mapping type A. A PDSCH (or PUSCH) transmitted using the mini-slot may be referred to as PDSCH (or PUSCH) mapping type B.

All of the radio frame, the subframe, the slot, the mini-slot, and the symbol represent time units at the time of transmitting a signal. The radio frame, the subframe, the slot, the mini-slot, and the symbol may have different names corresponding thereto, respectively.

For example, one subframe may be referred to as a transmission time interval (TTI), a plurality of consecutive subframes may be referred to as a TTI, and one slot or one mini-slot may be referred to as a TTI. That is, at least one of the subframe and the TTI may be a subframe (1 ms) in the existing LTE, may be a period (for example, one to thirteen symbols) shorter than 1 ms, or may be a period longer than 1 ms. Note that a unit representing the TTI may be referred to as a slot, a mini-slot, or the like rather than the subframe.

Here, the TTI refers to, for example, a minimum time unit of scheduling in radio communication. For example, in an LTE system, a base station performs scheduling that allocates radio resources (frequency bandwidths, transmission power, and the like, that can be used in each user terminal) to each user terminal in a unit of the TTI. Note that a definition of the TTI is not limited thereto.

The TTI may be a transmission time unit of a channel-encoded data packet (transport block), a code block, a codeword, or the like, or may be a processing unit such as scheduling, link adaptation, or the like. Note that when the TTI is given, a time section (for example, the number of symbols) in which the transport block, the code block, the codeword, or the like is actually mapped may be shorter than the TTI.

Note that in a case where one slot or one mini-slot is referred to as the TTI, one or more TTIs (that is, one or more slots or one or more mini-slots) may be a minimum time unit of scheduling. In addition, the number of slots (number of mini-slots) constituting the minimum time unit of the scheduling may be controlled.

A TTI having a time length of 1 ms may be referred to as a general TTI (TTI in LTE Rel. 8-12), a normal TTI, a long TTI, a general subframe, a normal subframe, a long subframe, a slot, and the like. A TTI shorter than the general TTI may be referred to as a shortened TTI, a short TTI, a partial or fractional TTI, a shortened subframe, a short subframe, a mini-slot, a sub-slot, a slot, and the like.

Note that the long TTI (for example, a general TTI, a subframe or the like) may be replaced with a TTI having a time length exceeding 1 ms and the short TTI (for example, a shortened TTI or the like) may be replaced with a TTI having a TTI length shorter than that of the long TTI and having a TTI length of 1 ms or more.

A resource block (RB) is a resource allocation unit in the time domain and the frequency domain, and may include one or a plurality of continuous subcarriers in the frequency domain. The number of subcarriers included in the RB may be the same regardless of the numerology, and may be, for example, 12. The number of subcarriers included in the RB may be determined based on the numerology.

In addition, the time domain of the RB may include one or a plurality of symbols, and may have a length of one slot, one mini-slot, one subframe, or one TTI. One TTI, one subframe, and the like, may each be configured with one or a plurality of resource blocks.

Note that one or a plurality of RBs may be referred to as a physical resource block (Physical RB: PRB), a subcarrier group (Sub-Carrier Group: SCG), a resource element group (Resource Element Group: REG), a PRB pair, an RB pair, and the like.

In addition, the resource block may be configured with one or a plurality of resource elements (Resource Elements: RE). For example, one RE may be a radio resource region of one subcarrier and one symbol.

A bandwidth part (Bandwidth Part: BWP) (which may be referred to as a partial bandwidth or the like) may represent a subset of contiguous common resource blocks (RBs) for a certain numerology in a certain carrier. Here, the common RB may be specified by an index of RBs based on a common reference point of the carrier. The PRB may be defined in a certain BWP and be numbered within the BWP.

The BWP may include an UL BWP and a DL BWP. For the UE, one or a plurality of BWPs may be configured in one carrier.

At least one of the configured BWPs may be active, and it may not be assumed that the UE transmits and receives a predetermined signal/channel outside the active BWP. Note that a “cell”, a “carrier”, or the like in the present disclosure may be replaced with the “BWP”.

The structures of the radio frame, the subframe, the slot, the mini-slot, the symbol, and the like, described above are merely examples. For example, a configuration such as the number of subframes included in the radio frame, the number of slots per subframe or radio frame, the number of mini-slots included in the slot, the number of symbols and RBs included in the slot or the mini-slot, the number of subcarriers included in the RB, the number of symbols in the TTI, the symbol length, and the cyclic prefix (CP) length can be variously changed.

The terms “connected”, “coupled”, or any variations thereof, mean any direct or indirect connection or coupling between two or more elements. Also, one or more intermediate elements may be present between two elements that are “connected” or “coupled” to each other. The coupling or connection between the elements may be physical, logical, or a combination thereof. For example, “connection” may be read as “access”. In the present disclosure, two elements can be “connected” or “coupled” to each other by using one or more wires, cables, printed electrical connections, and as some non-limiting and non-exhaustive examples, by using electromagnetic energy having wavelengths in the radio frequency domain, the microwave region and light (both visible and invisible) regions, and the like.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on”.

The “means” in the configuration of each of the above devices may be replaced with a “unit”, a “circuit” a, “device”, and the like.

Any reference to an element using a designation such as “first”, “second”, and the like used in the present disclosure generally does not limit the amount or order of those elements. Such designations can be used in the present disclosure as a convenient way to distinguish between two or more elements. Thus, the reference to the first and second elements does not imply that only two elements can be adopted, or that the first element must precede the second element in some or the other manner.

In the present disclosure, the used terms “include”, “including”, and variants thereof are intended to be inclusive in a manner similar to the term “comprising”. Furthermore, the term “or” used in the present disclosure is intended not to be an exclusive disjunction.

Throughout this disclosure, for example, during translation, if articles such as “a”, “an”, and “the” in English are added, in this disclosure, these articles shall include plurality of nouns following these articles.

The terms “determining” as used in this disclosure may encompass a wide variety of operations. The “determining” can include, for example, considering performing judging, calculating, computing, processing, deriving, investigating, looking up, search, or inquiry (for example, searching in a table, a database, or another data structure), or ascertaining as performing the “determining”. In addition, the “determining” can include considering performing receiving (for example, receiving information), transmitting (for example, transmitting information), input, output, or accessing (for example, accessing data in a memory) as performing the “determining”. In addition, the “determining” can include considering performing resolving, selecting, choosing, establishing, or comparing as performing the “determining”. That is, the “determining” can include considering some operation as performing the “determining”. In addition, the “determining” may be replaced with “assuming”, “expecting”, “considering”, and the like.

In the present disclosure, the term “A and B are different” may mean “A and B are different from each other”. It should be noted that the term may mean “A and B are each different from C”. Terms such as “leave”, “coupled”, or the like may also be interpreted in the same manner as “different”.

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### REFERENCE SIGNS LIST

10 Radio communication system
20 E-UTRAN
30 NG RAN
40 Core network
50 E-SMLC
100A eNB
100B gNB
110 Radio communication unit
120 Network connection unit
130 Measurement result reception unit
140 Measurement report transmission unit
150 Control unit
200 UE
1001 Processor
1002 Memory
1003 Storage
1004 Communication device
1005 Input device
1006 Output device
1007 Bus

1. A radio base station comprising:
transmission unit that transmits a measurement report according to a protocol based on a location service to a positioning server; and
a control unit that includes, in the measurement report, a measurement result of a cell belonging to a different radio access technology, together with identification information uniquely specifying the cell belonging to the different radio access technology.

2. The radio base station according to claim 1, wherein the control unit specifies the identification information by referring to correspondence information associating a cell belonging to the radio base station and the identification information with each other in a case where a measurement result has been received from a terminal existing in the cell belonging to the radio base station.

3. The radio base station according to claim 2, wherein the correspondence information associates at least any one of a frequency and physical cell identification information of the cell belonging to the different radio access technology with the cell belonging to the radio base station.

4. The radio base station according to claim 2, further comprising a reception unit that receives the correspondence information from a management server.

5. The radio base station according to claim 1, wherein the transmission unit transmits the measurement report according to a location information related protocol applied between the radio base station and the positioning server.

6. The radio base station according to claim 3, further comprising a reception unit that receives the correspondence information from a management server.

7. The radio base station according to claim 2, wherein the transmission unit transmits the measurement report according to a location information related protocol applied between the radio base station and the positioning server.

8. The radio base station according to claim 3, wherein the transmission unit transmits the measurement report according to a location information related protocol applied between the radio base station and the positioning server.

9. The radio base station according to claim 4, wherein the transmission unit transmits the measurement report according to a location information related protocol applied between the radio base station and the positioning server.
